(19) United States
(12) Patent Application Publication
(10) Pub. No.: US 2012/0265567 A1
(43) Pub. Date: Oct. 18, 2012

(54) OFFLINE CONVERSION REPORTING

(75) Inventor: Stephane MUSZYNSKI, Washington, DC (US)

(73) Assignee: Art Technology Group, Inc., Cambridge, MA (US)

(21) Appl. No.: 13/086,616

(22) Filed: Apr. 14, 2011

(51) Int. Cl. G06Q 10/00; G06Q 30/00

(52) U.S. Cl. 705/7.11

(57) ABSTRACT

A system can report an occurrence of an offline conversion with respect to an electronic commerce system. The system can then correlate information of the offline conversion with information comprised in one or more communication records to determine whether the offline conversion occurred as a result of a communication feature of the electronic commerce system, such as a click-to-call communication feature or a click-to-chat communication feature. The system can then report the offline conversion, and report that the offline conversion occurred as a result of the communication feature.

### FIELD

One embodiment is directed to a computer system, and more particularly, to an electronic commerce system, such as a web-based electronic commerce system.

### BACKGROUND

In an electronic commerce system, a conversion refers to a successful transaction that is completed by the electronic commerce system. For example, in an electronic purchase system, a conversion refers to a successful transaction that involves a customer purchasing a product that is offered by the electronic purchase system. As another example, in an electronic reservation system, a conversion refers to a customer successfully placing a reservation (such as an airline reservation, a hotel reservation, a train reservation, or a dinner reservation) that is offered by the electronic reservation system. In these examples, the successful completion of a transaction (i.e., conversion of a transaction) can be represented by the customer reaching a “transaction complete” page or screen displayed by the electronic commerce system. The reaching of the “transaction complete” page or screen can signify that a transaction has been successfully completed (i.e., converted), and the conversion can be reported by the electronic commerce system for auditing purposes.

One example of an electronic commerce system is a web-based electronic commerce system. A web-based electronic commerce system is an electronic commerce system that is distributed over one or more computers that form the Internet, such as the World Wide Web. A web-based electronic commerce system can include a communication feature. In a communication, two or more parties can communicate with each other over a data connection. Examples of communications include telephone communications, Internet text chat communications, and Internet video chat communications.

In some circumstances, a web-based electronic commerce system includes a web-based communication feature, such as a click-to-call or click-to-chat communication feature. In a web-based communication, a person can click an object (such as a button, image, text, or other type of icon) displayed on a page or screen of the web-based electronic commerce system, to request an immediate connection with another person, such as an agent. When the web-based communication is a click-to-call communication, the immediate connection may be a telephone connection. When the web-based communication is a click-to-chat communication, the immediate connection may be a web-based chat session. A customer may reach a “transaction complete” page or screen displayed by the web-based electronic commerce system only after consulting with an agent using either a click-to-call communication or a click-to chat communication.

### SUMMARY

One embodiment is directed to a computer-readable medium having instructions stored thereon that, when executed by a processor, cause the processor to report an offline conversion of an electronic commerce system. The instructions include generating event data that includes information of the offline conversion stored as a key parameter and one or more additional parameters. The instructions further include transmitting the event data to a report server, where the report server includes a plurality of communication records. The instructions further include comparing the key parameter of the event data with a parameter of the plurality of communication records to determine whether the key parameter of the event data matches a parameter of a communication record. The instructions further include generating a report record that comprises the event data and is linked to the communication record when the key parameter of the event data matches the parameter of the communication record.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a block diagram of a system that may implement an embodiment of the invention.

FIG. 2A illustrates a user interface that is displayed to a customer of an electronic commerce system, according to an embodiment of the invention.

FIG. 2B illustrates a user interface of a communication feature that is displayed to a customer of an electronic commerce system, according to an embodiment of the invention.

FIG. 3 illustrates an example electronic commerce system that utilizes an offline conversion reporting module, according to an embodiment of the invention.

FIG. 4 illustrates a flow diagram of the functionality of an offline conversion reporting module, according to an embodiment of the invention.

FIG. 5 illustrates a flow diagram of the functionality of executing an offline conversion reporting module from an agent console, according to an embodiment of the invention.

FIG. 6 illustrates a user interface of an agent console that executes an offline conversion reporting module, according to an embodiment of the invention.

FIG. 7 illustrates a flow diagram of the functionality of a customer relationship management system that executes an offline conversion reporting module, according to an embodiment of the invention.

FIG. 8 illustrates a user interface of a customer relationship management system that executes an offline conversion reporting module, according to an embodiment of the invention.

### DETAILED DESCRIPTION

According to an embodiment, a system can report an occurrence of a transaction that is completed outside of an electronic commerce system (i.e., an “offline conversion”). The system can then correlate information of the offline conversion with information comprised in one or more communication records to determine whether the offline conversion occurred as a result of a communication feature of the electronic commerce system, such as a click-to-call communication feature, or a click-to-chat communication feature. The system can then report the offline conversion, and report that the offline conversion occurred as a result of the communication feature.

As previously described, an online conversion of a electronic commerce system, such as a web-based electronic commerce system, can easily be reported through the availability of electronic records, after the successful conversion of an online transaction. However, there can be situations where the transaction is converted offline (i.e., outside the electronic commerce system). These situations are identified as “offline conversions.” For example, a user may initiate an online transaction using the electronic commerce system, and then may encounter a problem with the electronic commerce system. As another example, the user may initiate the online transaction using the electronic commerce system, but then may wish to speak with an agent before completing the online transaction, in order to obtain more information regarding a product that the user wishes to purchase. The user may initiate a click-to-call communication, or a click-to-chat communication, with an agent, and the agent may complete the customer's desired transaction using an internal customer relationship management (“CRM”) system, rather than the electronic commerce system, and thus, convert the transaction offline. Because the offline conversion does not involve the customer reaching a “transaction complete” page or screen displayed by the electronic commerce system, the offline conversion is generally not reported. This can lead to an underreporting of successful conversions, in particular, successful conversions that occur as a result of a click-to-call or click-to-chat communication session.

Manual efforts can be made to attempt to report these offline conversions. For example, a spreadsheet, such as a Microsoft® Excel® spreadsheet, can be used to manually correlate the offline conversion with the original online transaction. However, these manual efforts do not scale well, and still tend to result in an underreporting of successful conversion.

However, in general, it is important for electronic commerce system owners to track these offline conversions, because these conversions can represent a significant portion of incoming revenue generated by the electronic commerce system. Furthermore, if the offline conversions occur as a result of a communication feature, such as a web-based communication feature, these offline conversions should be recorded in order to show the successful qualities of the communication feature. Thus, certain embodiments of the invention can provide for a mechanism of reporting offline conversions, and, more particularly, reporting offline conversions that occur as a result of a communication feature.

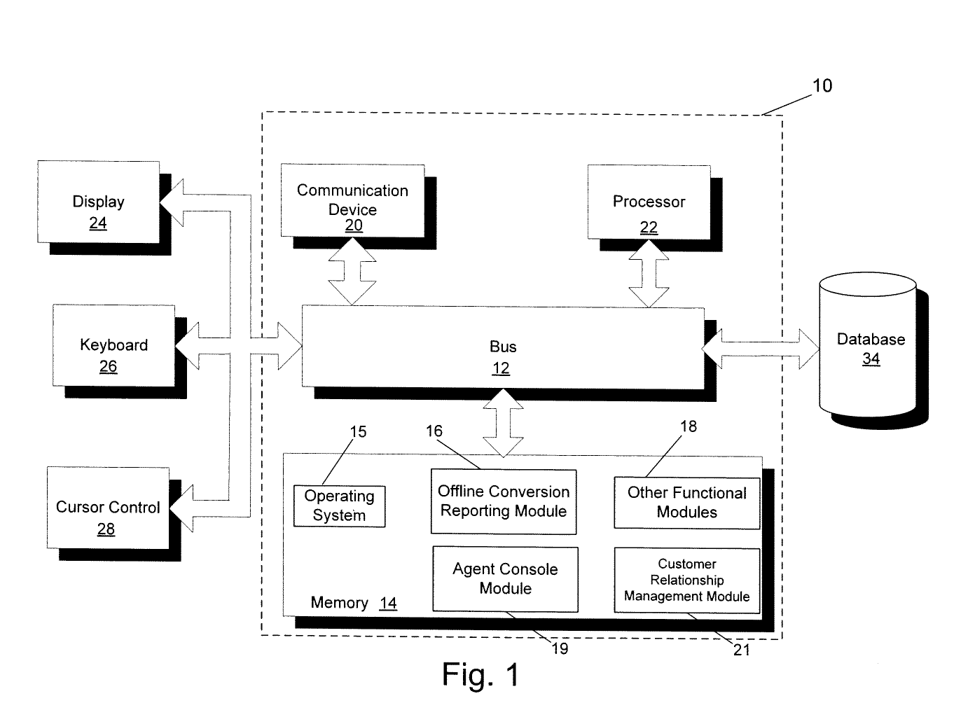

FIG. 1 illustrates a block diagram of a system 10 that may implement one embodiment of the invention. System 10 includes a bus 12 or other communication mechanism for communicating information between components of system 10. System 10 also includes a processor 22, operatively coupled to bus 12, for processing information and executing instructions or operations. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of machine or computer-readable medium. System 10 further includes a communication device 20, such as a network interface card or other communication interface, to provide access to a network. As a result, a user may interface with system 10 directly, or remotely through a network or any other method.

A computer-readable medium may be any available medium that can be accessed by processor 22. A computer-readable medium may include both a volatile and nonvolatile medium, a removable and non-removable medium, a communication medium, and a storage medium. A communication medium may include computer readable instructions, data structures, program modules or other data in a modulated data signal such as a carrier wave or other transport mechanism, and may include any other form of information delivery medium known in the art. A storage medium may include RAM, flash memory, ROM, erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

Processor 22 can also be operatively coupled via bus 12 to a display 24, such as a Liquid Crystal Display (“LCD”). Display 24 can display information to the user. A keyboard 26 and a cursor control device 28, such as a computer mouse, can also be operatively coupled to bus 12 to enable the user to interface with system 10.

According to one embodiment, memory 14 can store software modules that may provide functionality when executed by processor 22. The modules can include an operating system 15, an offline conversion reporting module 16, as well as other functional modules 18. Operating system 15 can provide an operating system functionality for system 10. Offline conversion reporting module 16 can provide functionality for reporting an offline conversion, as will be described in more detail below. In one embodiment, offline conversion reporting module 16 can be executed as a web service. As understood by one of ordinary skill in the art, a web service, or service, is a module designed to support interoperable system-to-system interaction over a network. System 10 can also be part of a larger system. Thus, system 10 can include one or more additional functional modules 18 to include the additional functionality. For example, functional modules 18 may include modules that are part of an ATG Optimization product from Art Technology Group, Inc.

In one embodiment, memory 14 also includes agent console module 19 and customer relationship management (“CRM”) module 21. Agent console module 19 can provide functionality for receiving information of an offline conversion, as will be described in more detail below. CRM module 21 can provide functionality for completing an offline conversion, as will also be described in more detail below. However, in alternate embodiments, memory 14 does not include these two modules, and instead, the functionality provided by these two modules can be provided by one or more additional systems that are operatively coupled to system 10.

Processor 22 can also be operatively coupled via bus 12 to a database 34. Database 34 can store data in an integrated collection of logically-related records or files. Database 34 can be an operational database, an analytical database, a data warehouse, a distributed database, an end-user database, an external database, a navigational database, an in-memory database, a document-oriented database, a real-time database, a relational database, an object-oriented database, or any other database known in the art. Furthermore, database 34 may store CRM data as part of an overall Enterprise Resource Planning (“ERP”) system.

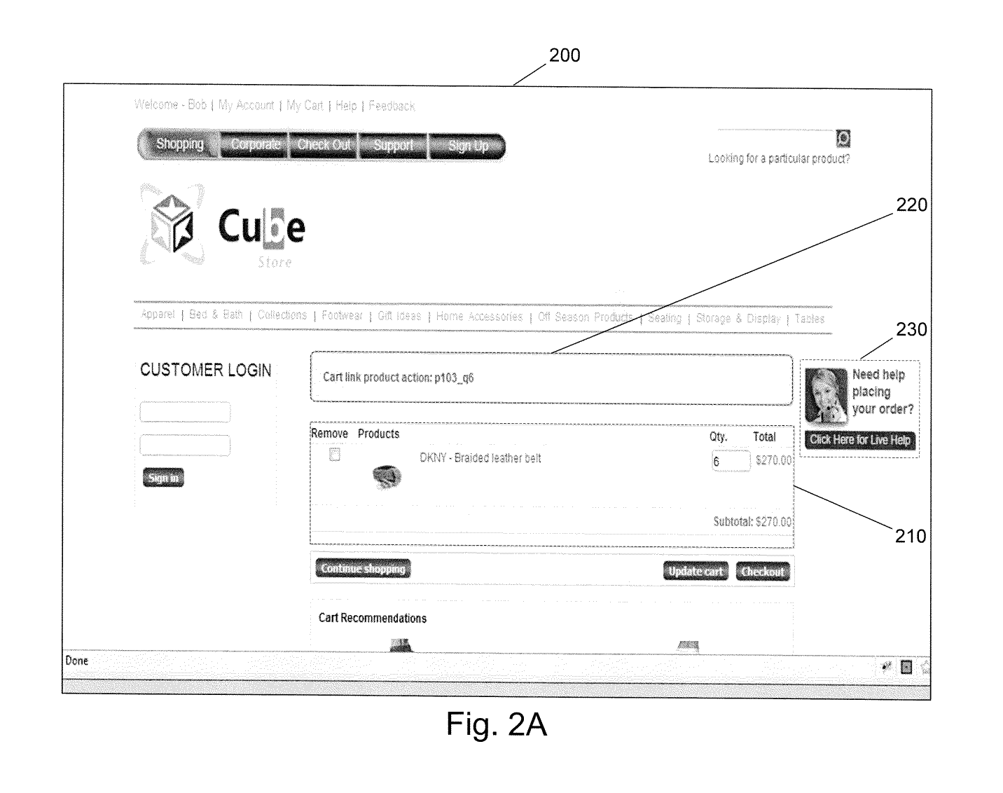

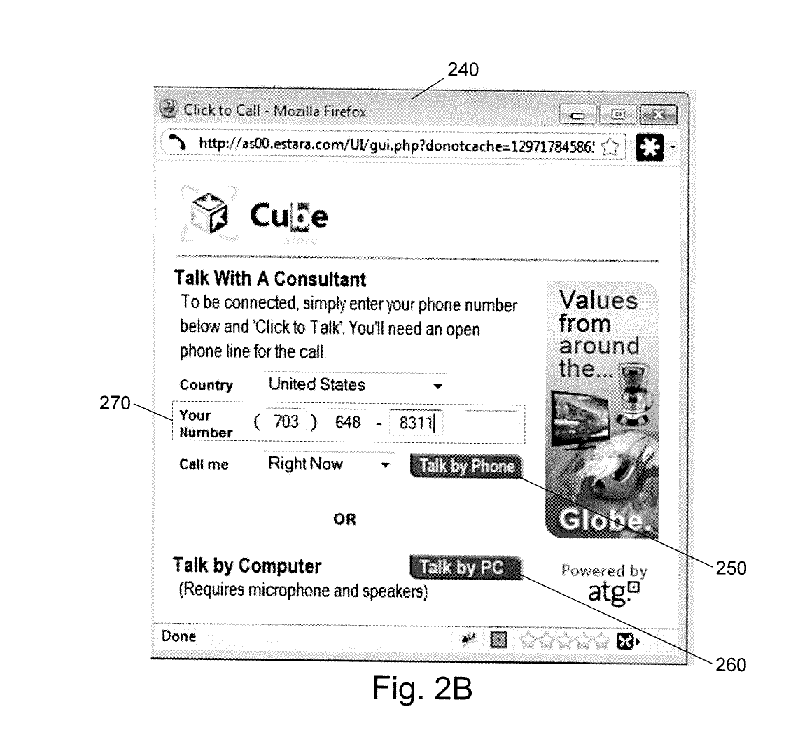

FIG. 2A illustrates a user interface 200 that is displayed to a customer of an electronic commerce system, according to an embodiment of the invention. According to the embodiment, the electronic commerce system is a web-based electronic commerce system that allows customers to engage in online transactions over the Internet, and user interface 200 can be displayed in a web browser of the customer, such as Microsoft® Internet Explorer®, Mozilla® Firefox®, and Google® Chrome®. Also in accordance with the embodiment, the electronic commerce system can be an electronic purchasing system that allows the customer to purchase products. More specifically, the electronic purchasing system can allow the customer to select products for purchase, and add the products to shopping cart 210. In the illustrated embodiment, the customer has selected a DKNY® braided leather belt product, and a quantity of 6, using the electronic purchasing system, resulting in a total purchase price of $270.00, as displayed in shopping cart 210.

In a conventional workflow, the customer can “click” on a button displayed in user interface 200 to purchase the product and convert the online transaction. This conventional workflow may involve navigating the customer to a “transaction complete” page or screen displayed by the electronic commerce system (not shown in FIG. 2A). By navigating to the “transaction complete” page or screen, the electronic commerce system can report the online conversion, and thus, report information of the online conversion (i.e., reporting information of the online transaction that is converted), such as the product(s), the quantity of each product, and the total purchase price.

However, according to an embodiment of the invention, the conventional workflow may be disrupted. For example, in the illustrated embodiment of FIG. 2A, user interface 200 may display an error message 220 in response to the customer “clicking” on a button displayed in user interface 200 to purchase the product. Because error message 220 is displayed, the customer does not reach the “transaction complete” page or screen, and thus, does not convert the transaction. This is merely an example of how the conventional workflow may be disrupted, and in alternate embodiments, the conventional workflow may be disrupted in other ways. Furthermore, in some embodiments, the conventional workflow can be disrupted due to a technical reason, whereas, in other embodiments, the conventional workflow can be disrupted due to a business reason, rather than a technical reason. For example, the customer may wish to obtain more information regarding the selected product before purchasing the product, and thus, may wish to speak with a customer service agent before converting the transaction.

According to the embodiment, the customer can initiate a communication with a customer service agent to resolve the error displayed by error message 220. The customer can initiate the communication by “clicking” on communication button 230. A communication can be a web-based communication, such as a click-to-call communication or a click-to-chat communication. As previously described, a click-to-call communication is a telephone connection that can be initiated through a “click” of an icon, such as communication button 230, and a click-to-chat communication is a web-based chat session that can also be initiated through a “click” of an icon, such as communication button 230. The communication is discussed below in greater detail in relation to FIG. 2B.

One of ordinary skill in the art would readily appreciate that FIG. 2A illustrates an example user interface of an example electronic commerce system, and that, in alternate embodiments, the user interface may have an alternate visual configuration, the electronic commerce system may have an alternate logical or physical configuration, or a combination of the two, and still be within the scope of the invention.

FIG. 2B illustrates a user interface 240 of a communication feature that is displayed to a customer of an electronic commerce system, according to an embodiment of the invention. According to the embodiment, user interface 240 is displayed to the customer in response to the customer “clicking” on communication button 230. In the illustrated embodiment, the communication feature is a web-based communication feature.

According to the embodiment, user interface 240 can facilitate either a click-to-call communication, or a click-to-chat communication, with a customer service agent. By facilitating either a click-to-call communication, or a click-to-chat communication, user interface 240 will ideally allow the customer service agent to resolve any error that the customer is experiencing, or otherwise address the customer's questions or concerns, and to convert the customer's transaction online, in one embodiment. The online conversion can be reported by the electronic commerce system. In an alternate embodiment, the agent can convert the customer's transaction offline. This offline conversion that results from the communication with the agent can then be reported using an offline conversion reporting module (such as offline conversion reporting module 16 of FIG. 1), as will be discussed below in greater detail.

According to the embodiment, user interface 240 can display click-to-call button 250 and click-to-chat button 260. By “clicking” on click-to-call button 250, the customer can initiate a telephone connection with a customer service agent. According to the embodiment, the customer can first enter a telephone number in field 270. Upon “clicking” on click-to-call button 250, user interface 240 can transmit the phone number to a call center where the customer service agent is stationed. The call center can subsequently use the phone number to call the customer, and connect the customer with the agent, and allow the agent to communicate with the customer. Furthermore, by “clicking” on click-to-chat button 260, the customer can initiate a web-based chat session with the customer service agent. The web-based chat session can be a web-based text chat session, or a web-based video chat session. According to the embodiment, upon “clicking” on click-to-chat button 260, user interface 240 can create a session identity and transmit the session identity to a call center where the customer service agent is stationed. The call center can subsequently use the session identity to connect the agent to the chat session, and allow the agent to communicate with the customer. Through either a click-to-call communication session, or a click-to-chat communication session, the agent can convert the customer's transaction online, in one embodiment. The online conversion can be reported by the electronic commerce system. In an alternate embodiment, the agent can convert the customer's transaction offline. The offline conversion can then be reported using an offline conversion reporting module (such as offline conversion reporting module 16 of FIG. 1), as will be discussed below in greater detail.

One of ordinary skill in the art would readily appreciate that FIG. 2B illustrates an example user interface of an example communication feature, and that, in alternate embodiments, the user interface may have an alternate visual configuration, and still be within the scope of the invention.

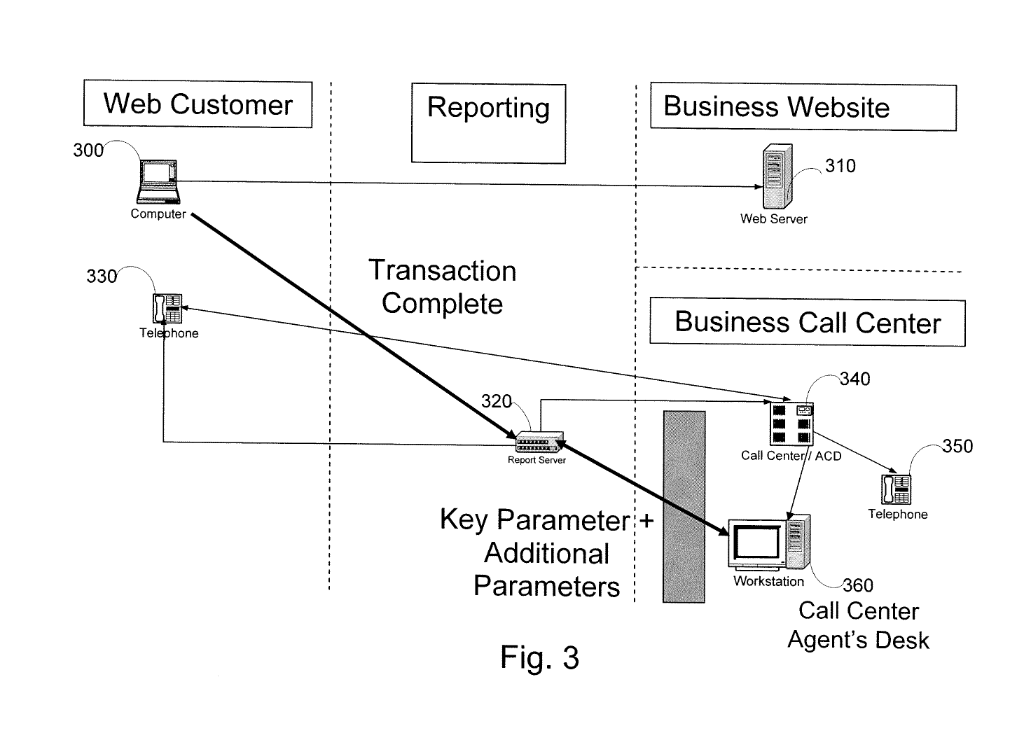

FIG. 3 illustrates an example electronic commerce system that utilizes an offline conversion reporting module, according to an embodiment of the invention. According to the embodiment, the electronic commerce system can be a web-based electronic commerce system that allows customers to engage in online transactions over the Internet. In the illustrated embodiment, the electronic commerce system is divided into four tiers; the web customer tier (identified in FIG. 3 as “Web Customer”), the reporting tier (identified in FIG. 3 as “Reporting”), the business website tier (identified in FIG. 3 as “Business Website”), and the business call center tier (identified in FIG. 3 as “Business Call Center”). The business call center tier includes a workstation at a call center agent's desk (identified in FIG. 3 as “Call Center Agent's Desk”).

According to the embodiment, a customer uses computer 300 to establish a connection with web server 310, where the electronic commerce system is deployed. Once connected, a user interface is displayed to the customer in computer 300. In one embodiment, the user interface is similar to the user interface illustrated in FIG. 2A. The customer can use the user interface displayed in computer 300 to initiate an online transaction as previously described in relation to FIG. 2A. In one embodiment, the customer can complete (i.e., convert) the online transaction utilizing the electronic commerce system deployed at web server 310. The conversion of the online transaction can include navigating to a “transaction complete” page or screen displayed by the electronic commerce system deployed at web server 310. According to the embodiment, by navigating to the “transaction complete” page or screen, the transaction is converted by the electronic commerce system. Thus, the online conversion is reported, and the information of the online conversion can be transmitted to report server 320 (illustrated in FIG. 3 as “Transaction Complete”).

In an alternate embodiment, the customer can initiate a communication before converting the online transaction utilizing the electronic commerce system deployed at web server 310. In one embodiment, a user interface is displayed to the customer that is similar to the user interface illustrated in FIG. 2B. According to the illustrated embodiment of FIG. 3, the customer can initiate a click-to-call communication by entering a phone number at computer 300, as previously described in relation to FIG. 2B. In the illustrated embodiment, the phone number is the number of telephone 330. The phone number is subsequently transmitted to report server 320, where a click-to-call record is created that includes the phone number as a parameter. The click-to-call record is a record that a customer initiated a click-to-call communication from computer 300, using the number of telephone 330.

According to the embodiment, report server 320 establishes a first telephone connection with the customer at telephone 330 and establishes a second telephone connection with call center/automatic call distributor (ACD) 340, and bridges the two telephone connections together so that that the customer at telephone 330 is connected to call center/ACD 340. Call center/ACD 340 subsequently routes the bridged telephone call to an agent at telephone 350. Thus, the customer at telephone 330 is connected to the agent at telephone 350.

In one embodiment, the agent at telephone 350 can convert the customer's transaction online. According to the embodiment, the agent can guide the customer to convert the transaction online using the electronic commerce system deployed at web server 310, and displayed at computer 300. This can involve guiding the customer to a “transaction complete” page or screen, as previously described. As also previously described, by navigating to the “transaction complete” page or screen, the information of the online conversion can be transmitted to report server 320 (illustrated in FIG. 3 as “Transaction Complete”). However, according to this embodiment, the electronic commerce system can determine that the customer initiated a communication before the online conversion, and thus, the online conversion can also be reported as occurring as a result of the communication.

In an alternate embodiment, the agent at telephone 350 can convert the customer's transaction offline. According to the embodiment, information of the transaction can be transmitted to a workstation 360, where the agent can view the information of the transaction. In one embodiment, workstation 360 is a system, such as system 10 of FIG. 1. The agent can then convert the transaction offline, at the agent's desk. For example, the agent can utilize an internal CRM system to capture and process the information of the transaction, and thus, convert the transaction using the CRM system. After the offline transaction has been converted, the offline conversion can be reported to report server 320 using an offline conversion reporting module (such as offline conversion reporting module 16 of FIG. 1) that is executed at workstation 360, as will be discussed below in greater detail. By reporting the offline conversion, event data that includes information of the offline conversion, and that is stored as a key parameter and one or more additional parameters, can be transmitted to report server 320 (illustrated in FIG. 3 as “Key Parameter+Additional Parameters”). Furthermore, telephones 330 and 350 can be integrated into other devices.

In one embodiment, the offline conversion reporting module can be integrated with the CRM system so that the offline conversion reporting module is executed in response to the CRM system completing the offline conversion. In an alternate embodiment, the offline conversion reporting module can be integrated with a separate agent console. According to the alternate embodiment, the agent console can receive information of the offline conversion. In one embodiment, the agent console receives the information when the agent enters the information using a user interface of the agent console. The offline conversion reporting module can then be executed in response to the receiving of the information. According to the embodiment, the electronic commerce system can determine that the customer initiated a communication before the offline conversion, and thus, the offline conversion can also be reported as occurring as a result of the communication.

In the illustrated embodiment of FIG. 3, the communication is a click-to-call communication. However, in an alternate embodiment, the communication can be a click-to-chat communication. According to the alternate embodiment, rather than establishing a telephone connection between the customer and the agent, the report server can establish a web-based chat session between the customer and the agent. The chat session can be a web-based video chat session, or a web-based text chat session. In the alternate embodiment, rather than creating a click-to-call record that includes the customer's phone number, a chat session identity is created at computer 300, and the chat session identity is subsequently transmitted to report server 320, where a click-to-chat record is created that includes the chat session identity as a parameter. The click-to-chat record is a record that a customer initiated a click-to-chat communication from computer 300, using the chat session identity.

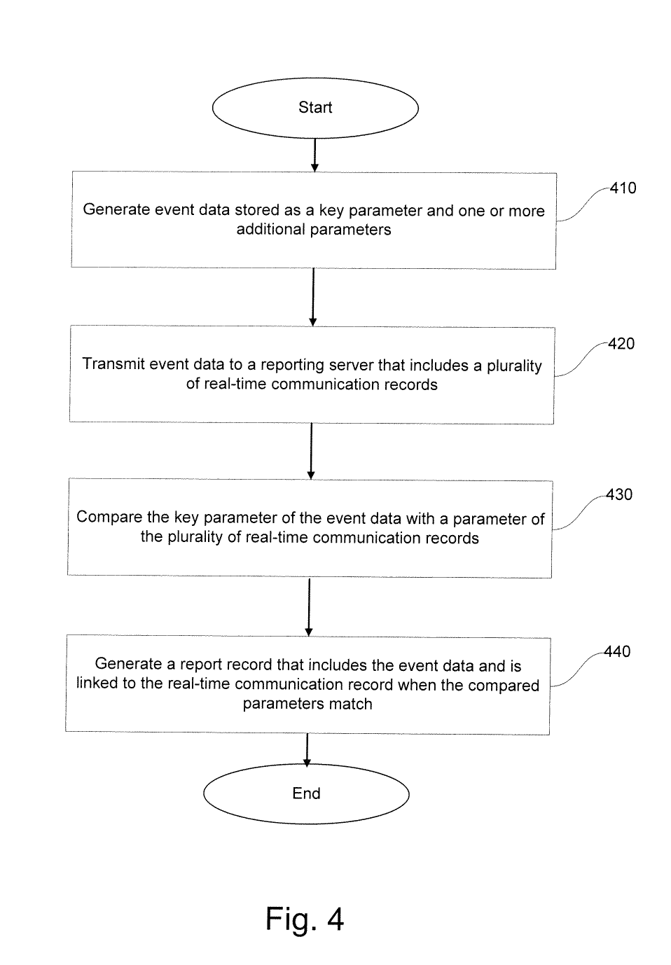

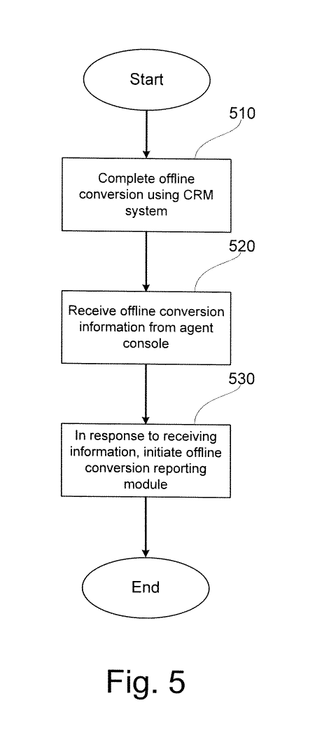

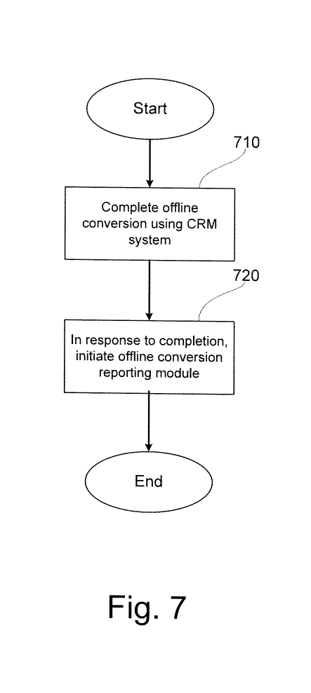

FIG. 4 illustrates a flow diagram of the functionality of an offline conversion reporting module according to an embodiment of the invention. In one embodiment, the functionality of the flow diagram of FIG. 4, and the functionality of the flow diagrams of FIGS. 5 and 7, are implemented by software stored in memory or other computer-readable or tangible medium, and executed by a processor. In other embodiments, each functionality may be performed by hardware (e.g., through the use of an application specific integrated circuit (“ASIC”), a programmable gate array (“PGA”), a field programmable gate array (“FPGA”), etc.), or any combination of hardware and software.

According to an embodiment, the offline conversion reporting module can be executed after an offline conversion of an electronic commerce system has been completed. At 410, event data is generated that includes information of the offline conversion stored as a key parameter and one or more additional parameters. In one embodiment, the event data that is generated is stored in an extensible markup language (“XML”) document.

Below is an example of event data that includes information of an offline conversion stored as a key parameter and additional parameters:

```
<WebEvents>
  <Events>
    <Event>
      <Phone>17036488311</Phone>
      <EventType>Transaction Complete</EventType>
      <var1>$345.00</var1>
      <var2>OJOISE231</var2>
    </Event>
  </Events>
</WebEvents>
```

In the above example, the parameter <WebEvents> indicates that a record is to be generated that contains the data contained within the parameter. The <Events> parameter indicates that the event data includes one or events. The <Event> parameter indicates that one or more parameters are associated with an event. The <Phone> parameter indicates a phone number of the customer of the offline transaction. In the illustrated example, the value of the <Phone> parameter is “17036488311.” According to the embodiment, the <Phone> parameter is a key parameter. A key parameter is used to compare the event data with one or more communication records, as is discussed below in greater detail. In an embodiment, the <Phone> parameter can include a phone number associated with a click-to-call communication. This can indicate that the offline conversion occurred as a result of a click-to-call communication. The <EventType> parameter indicates the type of the event. In the illustrated example, the value of the <EventType> parameter is “TransactionComplete” which indicates an offline conversion (i.e., a completion of an offline transaction). The parameters <var1> and <var2> indicate information of the offline conversion. In the illustrated example, the value for <var1> is “$345.00,” which represents a total purchase value of the offline conversion, and the value for <var2> is “OJOISE231” which represents an order identity of the offline conversion. According to the embodiment, the <Phone> parameter is the key parameter of the event data, and the <EventType>, <var1>, and <var2> parameters are the additional parameters of the event data.

One of ordinary skill in the art would readily understand that the above example is merely an example of event data, and that, in alternate embodiments, event data can take many forms and still be within the scope of the invention. For example, according to an embodiment, the event data can include an <EventDate> parameter. The <EventDate> parameter can indicate a date that the offline conversion occurred. As another example, according to an embodiment, the event data can include a <Window> parameter. The <Window> parameter can identify a time window that can be used to limit a number of communication records that are compared with the event data to only the communication records that are within the time window. Furthermore, the event data can include any number of <var> parameters, where each <var> parameter indicates information of the offline conversion. In addition, instead of a <Phone> parameter, the event data can include a <SessionIdentity> parameter. The <SessionIdentity> parameter can indicate a chat session identity of the customer. According to the embodiment, the <SessionIdentity> parameter can be a key parameter. In an embodiment, the <SessionIdentity> parameter can include a chat session identity associated with a click-to-chat communication. This can indicate that the offline conversion occurred as a result of a click-to-chat communication.

At 420, the event data is transmitted to a report server, such as report server 320 of FIG. 3, where the report server includes a plurality of communication records. According to the embodiment, each communication record of the plurality of communication records is a record of a communication between a customer and a customer service agent. A communication record can be a click-to-call communication record. A click-to-call communication record is a record of a click-to-call communication between a customer and a customer service agent. A communication record can also be a click-to-chat communication record. A click-to-chat communication record is a record of a click-to-chat communication between a customer and a customer service agent.

At 430, the key parameter of the event data is compared with a parameter of the plurality of communication records to determine whether the key parameter of the event data matches a parameter of a communication record. According to the embodiment, if the key parameter of the event data matches the parameter of the communication record, this means that the offline conversion that is represented by the event data occurred as a result of the communication represented by the communication record.

In an embodiment where the communication record is a click-to-call communication record, both the key parameter of the event data and the parameter of the click-to-call communication record are phone numbers. In an embodiment where the communication record is a click-to-chat communication record, both the key parameter of the event data and the parameter of the click-to-chat communication record are chat session identities.

According to an embodiment, if one of the additional parameters of the event data is a time window parameter, the key parameter of the event data is only compared with the parameter of communication records that are within the time window. For example, if the event data includes a time window parameter of 200 minutes, the key parameter of the event data is only compared with the parameter of communication records that were recorded within 200 minutes of when the offline conversion was completed. According to the embodiment, by utilizing a time window parameter, fewer communication records need to be compared, and the comparison can be completed in a shorter time duration.

At 440, a report record is generated that includes the event data and is linked to the communication record when the key parameter of the event data matches the parameter of the communication record. According to the embodiment, the report record represents an occurrence of an offline conversion. Furthermore, the report record represents that the offline conversion occurred as a result of a communication.

In one embodiment, when the key parameter of the event data matches the parameter of the communication record, a return code indicating a successful match can be returned. In the embodiment, when the key parameter of the event data does not match the parameter of any of the communication records, a return code indicating a unsuccessful match can be returned.

In one embodiment, the offline conversion is completed by the agent using an internal system, such as a CRM system. According to the embodiment, a CRM system is a system configured to allow a customer service agent to create and modify orders in an electronic commerce system, search and display existing orders in the electronic commerce system, view existing order histories in the electronic commerce system, complete partial orders in the electronic commerce system, and to access order fulfillment status of existing orders in the electronic commerce system.

In one embodiment, the CRM system is part of a system that includes an offline conversion reporting module, such as system 10 of FIG. 1. In the embodiment where the CRM system is part of the system that includes an offline conversion reporting module, the CRM system includes a CRM module. In another embodiment, the CRM system is a separate system that is operatively coupled to a system that includes an offline conversion reporting module, such as system 10 of FIG. 1. In the embodiment where the CRM system is a separate system, the CRM system includes a separate processor for processing information and executing instructions or operations, and a separate memory for storing information and instructions to be executed by the processor, where the separate memory includes a CRM module, such as CRM module 21 of FIG. 1.

According to the embodiment, after the offline conversion is completed using the CRM system, information regarding the offline conversion is received from an agent console. In one embodiment, the agent enters the information regarding the offline conversion into a user interface of the agent console. In another embodiment, the agent runs a script that enters the information regarding the offline conversion into the agent console. An agent console is a system configured to allow a customer service agent to synchronize incoming click-to-call communications, or click-to-chat communications, with a customer's web session data. Thus, an agent console can allow the agent to see a current web page of a electronic commerce system that is displayed to the customer, recent customer browser history, information regarding a communication of a customer (if a customer has initiated a communication with the agent) and other customer details. The agent console can include a user interface that displays the aforementioned data to the agent, and allows the agent to enter information regarding an offline conversion. The user interface of the agent console can include integration panels, or tabs, for customer service management, order management, or case management tools.

In one embodiment, the agent console is part of a system that includes an offline conversion reporting module, such as system 10 of FIG. 1. In the embodiment where the agent console is part of the system that includes an offline conversion reporting module, the agent console includes an agent console module. In another embodiment, the agent console is a separate system that is operatively coupled to a system that includes an offline conversion reporting module, such as system 10 of FIG. 1. In the embodiment where the agent console is a separate system, the agent console includes a separate processor for processing information and executing instructions or operations, and a separate memory for storing information and instructions to be executed by the processor, where the separate memory includes an agent console module, such as agent console module 19 of FIG. 1.

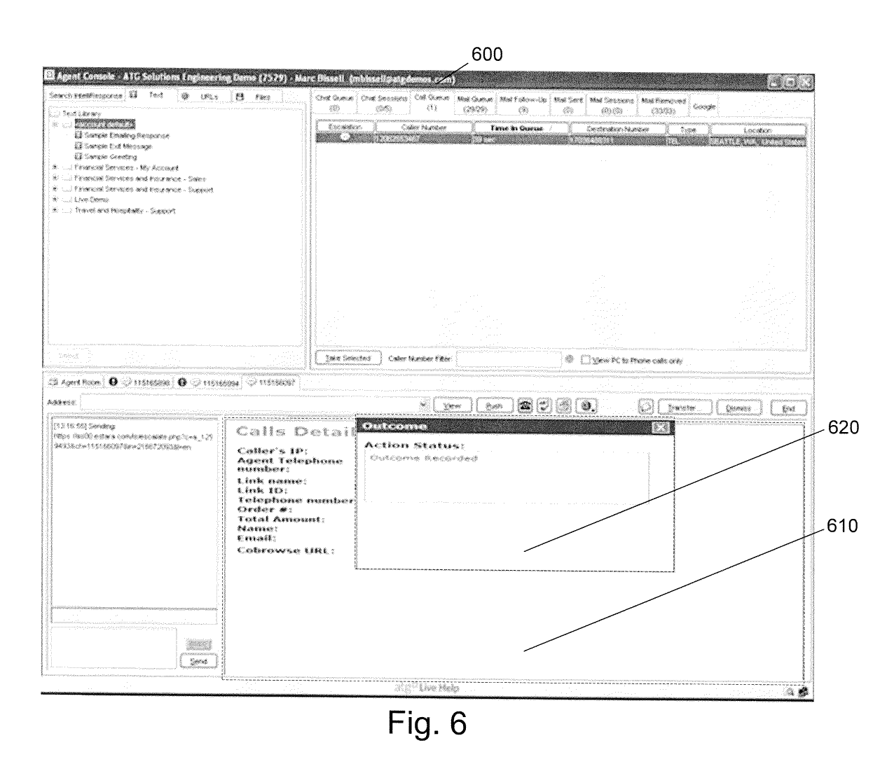

According to the embodiment, in response to receiving the information regarding the offline conversion from the agent console, an offline conversion reporting module is executed from the agent console. The offline conversion reporting module subsequently performs the functionality previously described in relation to FIG. 4. This embodiment is described below in greater detail in relation to FIGS. 5 and 6.

In an embodiment where the offline conversion is completed using the internal system, such as a CRM system, but an offline conversion reporting module is executed from the agent console, the agent console can receive information regarding a plurality of offline conversions. For example, every evening the agent can enter information regarding the offline conversions that occurred that day into the agent console. In one embodiment, the agent enters the information regarding the offline conversions into a user interface of the agent console. In an alternate embodiment, the agent runs a script that enters the information regarding the offline conversions into the agent console.

According to the embodiment, in response to receiving the information regarding the offline conversions, the offline conversion reporting module is executed for each offline conversion of the plurality of offline conversions. Furthermore, in accordance with the embodiment, the event data that is generated includes information of the plurality of offline conversions stored as a plurality of key parameters and one or more additional parameters.

Below is an example of event data that includes information of a plurality of conversions stored as a plurality of key parameters and additional parameters:

```
<WebEvents>
  <Events>
    <Event>
      <Phone>17036488311</Phone>
      <EventType>Transaction Complete</EventType>
      <EventDate>20080928-10:32</EventDate>
      <var1>$345.00</var1>
      <var2>OJOISE231</var2>
    </Event>
    <Event>
      <Phone>17036488312</Phone>
      <EventType>Visited New Site</EventType>
      <EventDate>20080928-14:56</EventDate>
      <Window>60</Window>
    </Event>
    <Event>
      <Phone>17036488313</Phone>
      <EventType>Transaction Complete</EventType>
      <EventDate>20080928-15:02</EventDate>
      <var1>$55.00</var1>
      <var2>UYETHE876</var2>
    </Event>
  </Events>
</WebEvents>
```

The above example of event data is similar to the previous example of event data, but instead, three events are included in the event data, rather than one, where each event represents an offline conversion. According to the embodiment, the <Phone> parameter is a key parameter for each event, and each key parameter is used to compare each event with one or more communication records. One of ordinary skill in the art would readily understand that the above example is merely an example of event data, and that, in alternate embodiments, event data can take many forms and still be within the scope of the invention.

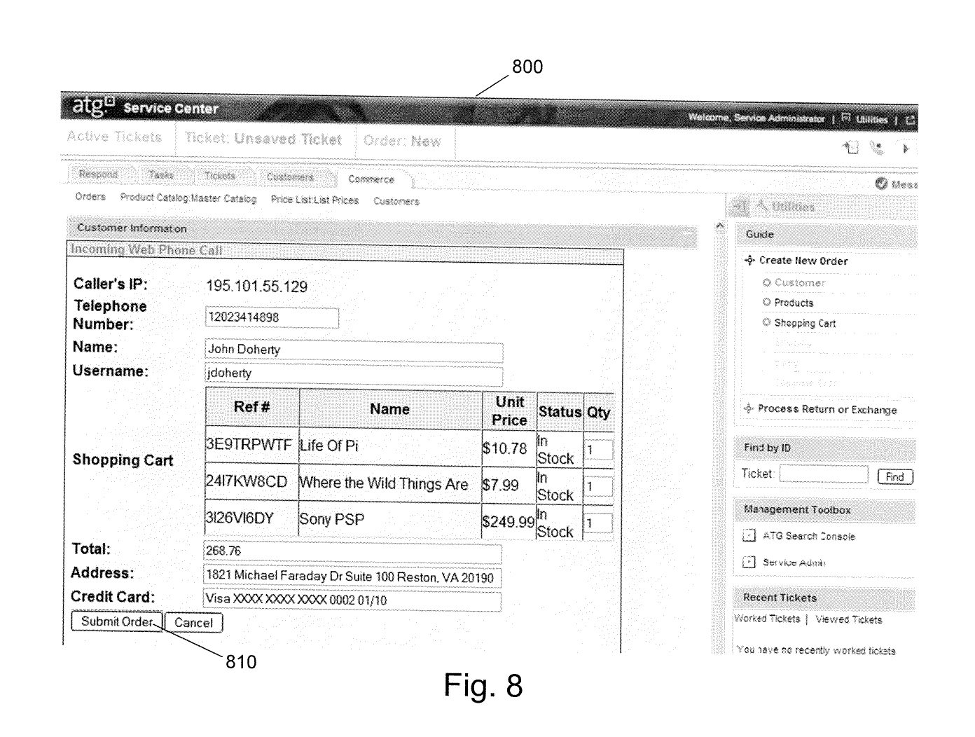

In an alternate embodiment, the offline conversion is completed by the agent using the internal system, such as a CRM system, and the CRM system executes an offline conversion reporting module in response to the completion of the offline conversion. The offline conversion reporting module subsequently performs the functionality previously described in relation to FIG. 4. This embodiment is described below in greater detail in relation to FIGS. 7 and 8.

FIG. 5 illustrates a flow diagram of the functionality of executing an offline conversion reporting module from an agent console, according to an embodiment of the invention. At 510, an offline conversion is completed using a CRM system. According to an embodiment, an agent can utilize the CRM system to convert a transaction originally initiated by a customer using an electronic commerce system, or to initiate and convert a new transaction at the request of a customer. In one embodiment, the customer can contact the agent using a communication, such as a click-to-call communication, or a click-to-chat communication.

At 520, information of the offline conversion is received from an agent console. According to an embodiment, the agent can enter the information regarding the offline conversion into a user interface of the agent console. According to an alternate embodiment, the agent can run a script that enters the information regarding the offline conversion into the agent console.

At 530, in response to receiving the information regarding the offline conversion, an offline conversion reporting module is executed from the agent console. According to an embodiment, the offline conversion reporting module is integrated with the agent console, so that the agent can execute the offline conversion reporting module through the interaction of the user interface of the agent console. For example, the agent can execute the offline conversion reporting module by “clicking” on an icon displayed in the user interface of the agent console. In the example, by “clicking” on the icon, the agent executes the offline conversion reporting module. According to the embodiment, the offline conversion reporting module performs the functionality previously described in relation to FIG. 4.

FIG. 6 illustrates a user interface 600 of an agent console that executes an offline conversion reporting module, according to an embodiment of the invention. According to the embodiment user interface 600 of the agent console can display one or more configurable screens or tabs. A module, such as an offline conversion reporting module, can be integrated within each of the configurable screens or tabs. In the illustrated embodiment, user interface 600 displays screen 610, which is integrated with the offline conversion reporting module. According to the embodiment, an agent can enter information regarding an offline conversion within screen 610, upon which the agent console receives the information regarding the offline conversion. Upon entering the information regarding the offline conversion, the agent can execute the offline conversion reporting module using user interface 600. According to the embodiment, the offline conversion reporting module performs the functionality previously described in relation to FIG. 4. Once the offline conversion reporting module has completed, a status message 620 can be displayed to the agent within user interface 600, according to the embodiment.

One of ordinary skill in the art would readily appreciate that FIG. 6 illustrates an example user interface of an agent console, and that, in alternate embodiments, the user interface may have an alternate visual configuration, and still be within the scope of the invention.

FIG. 7 illustrates a flow diagram of the functionality of a customer relationship management system that executes an offline conversion reporting module, according to an embodiment of the invention. At 710, an offline conversion is completed using a CRM system. According to an embodiment, an agent can utilize the CRM system to convert a transaction originally initiated by a customer using an electronic commerce system, or to initiate and convert a new transaction at the request of a customer. In one embodiment, the customer can contact the agent using a communication, such as a click-to-call communication, or a click-to-chat communication.

At 720, in response to the completion of the offline conversion, an offline conversion reporting module is executed from the CRM system. According to an embodiment, the offline conversion reporting module is integrated with the CRM system, so that the offline conversion reporting module is executed upon the completion of an offline conversion. Thus, in one embodiment, the offline conversion reporting module can be executed without requiring any action from the agent after the agent has completed the offline conversion. According to the embodiment, the offline conversion reporting module performs the functionality previously described in relation to FIG. 4.

FIG. 8 illustrates a user interface 800 of a customer relationship management system that executes an offline conversion reporting module, according to an embodiment of the invention. According to the embodiment, user interface 800 can display customer information, such as the customer's name, Internet Protocol address, and telephone number, to an agent. Also according to the embodiment, user interface 800 can display information regarding a transaction initiated by the customer, such as product name, product identity, product price, product quantity, and total price, to the agent. According to the embodiment, the agent can convert the transaction using the CRM system, by “clicking” on button 810 (which is entitled “Submit Order” in FIG. 8). According to the embodiment, button 810 is integrated with the offline conversion reporting module. Thus, by “clicking” on button 810, the agent can also execute the offline conversion reporting module using user interface 800. Thus, in response to the conversion being completed using the CRM system, the CRM system executes the offline conversion reporting module, without requiring the agent to perform any additional steps. According to the embodiment, the offline conversion reporting module performs the functionality previously described in relation to FIG. 4.

One of ordinary skill in the art would readily appreciate that FIG. 8 illustrates an example user interface of a CRM system, and that, in alternate embodiments, the user interface may have an alternate visual configuration, and still be within the scope of the invention.

In accordance with an embodiment, a computer-readable medium, computer-implemented method, and system is provided for reporting offline conversions, and in particular, reporting offline conversions that occur as a result of a communication between a customer and an agent. Thus, according to the embodiment, offline conversions are reported, that would not necessarily be reported in a conventional electronic commerce system. Furthermore, offline conversions that occur as a result of communication features of the electronic commerce system are reported, which highlight the successful qualities of the communication features. By providing more accurate figures regarding the number of offline conversions that occur as a result of the communication features, an owner of the electronic commerce system can more accurately gauge the success of the communication features, and thus, more accurately determine a return on investment that the owner is receiving.

The features, structures, or characteristics of the invention described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present invention. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the invention as discussed above may be practiced with steps in a different order, and/or with elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer-readable medium having instructions stored thereon that, when executed by a processor, cause the processor to report an offline conversion of an electronic commerce system, the instructions comprising:
generating event data that comprises information of the offline conversion stored as a key parameter and one or more additional parameters;
transmitting the event data to a report server, wherein the report server comprises a plurality of communication records;
comparing the key parameter of the event data with a parameter of the plurality of communication records to determine whether the key parameter of the event data matches a parameter of a communication record; and
generating a report record that comprises the event data and is linked to the communication record when the key parameter of the event data matches the parameter of the communication record.

2. The computer-readable medium of claim 1, the instructions further comprising:
completing the offline conversion using a customer relationship management system;
receiving the information of the offline conversion from an agent console; and
in response to receiving the information, executing the generating event data instructions, the transmitting the event data instructions, the comparing instructions, and the generating the report record instructions, from the agent console.

3. The computer-readable medium of claim 2, the instructions further comprising:
completing a plurality of offline conversions;
receiving the information of the plurality of offline conversions from the agent console; and
in response to receiving the information, executing the generating event data instructions, the transmitting the event data instructions, the comparing instructions, and the generating the report record instructions, from the agent console, for each offline conversion of the plurality of offline conversions;
wherein the event data comprises information of the plurality of offline conversions stored as a plurality of key parameters and one or more additional parameters.

4. The computer-readable medium of claim 1, the instructions further comprising:
completing the offline conversion using a customer relationship management system; and
in response to the completion of the offline conversion, executing the generating event data instructions, the transmitting the event data instructions, the comparing instructions, and the generating the report record instructions, from the customer relationship management system.

5. The computer-readable medium of claim 1, wherein the offline conversion occurs as a result of a click-to-call communication, and wherein the communication record comprises a click-to-call communication record.

6. The computer-readable medium of claim 6, wherein the key parameter comprises a phone number.

7. The computer-readable medium of claim 1, wherein the offline conversion occurs as a result of a click-to-chat communication, and wherein the communication record comprises a click-to-chat communication record.

8. The computer-readable medium of claim 7, wherein the key parameter comprises a chat session identity.

9. The computer-readable medium of claim 1, wherein the event data is stored within a extensible markup language document.

10. The computer-readable medium of claim 1, wherein one of the one or more additional parameters comprises a time window, and wherein the comparing the key parameter of the event data further comprises only comparing the key parameter of the event data with the parameter of communication records that are within the time window.

11. A computer-implemented method for reporting an offline conversion of an electronic commerce system, the method comprising:
generating event data that comprises information of the offline conversion stored as a key parameter and one or more additional parameters;
transmitting the event data to a report server, wherein the report server comprises a plurality of communication records;
comparing the key parameter of the event data with a parameter of the plurality of communication records to determine whether the key parameter of the event data matches a parameter of a communication record; and
generating a report record that comprises the event data and is linked to the communication record when the key parameter of the event data matches the parameter of the communication record.

12. The computer-implemented method of claim 11, further comprising:
completing the offline conversion using a customer relationship management system;
receiving the information of the offline conversion from an agent console; and
in response to receiving the information, executing the generating event data, the transmitting the event data, the comparing, and the generating the report record, from the agent console.

13. The computer-implemented method of claim 12, further comprising:
completing a plurality of offline conversions;
receiving the information of the plurality of offline conversions from the agent console; and
in response to receiving the information, executing the generating event data, the transmitting the event data, the comparing, and the generating the report record, from the agent console, for each offline conversion of the plurality of offline conversions;
wherein the event data comprises information of the plurality of offline conversions stored as a plurality of key parameters and one or more additional parameters.

14. The computer-implemented method of claim 11, further comprising:
completing the offline conversion using a customer relationship management system; and
in response to the completion of the offline conversion, executing the generating event data, the transmitting the event data, the comparing, and the generating the report record, from the customer relationship management system.

15. The computer-implemented method of claim 11, wherein the offline conversion occurs as a result of a click-to-call communication, and wherein the communication record comprises a click-to-call communication record.

16. The computer-implemented method of claim 11, wherein the offline conversion occurs as a result of a click-to-chat communication, and wherein the communication record comprises a click-to-chat communication record.

17-20. (canceled)

21. A system comprising:
an event data generator that generates event data that comprises information of an offline conversion stored as a key parameter and one or more additional parameters;
an event data transmitter that transmits the event data to a report server, wherein the report server comprises a plurality of communication records;
a parameter comparator that compares the key parameter of the event data with a parameter of the plurality of communication records to determine whether the key parameter of the event data matches a parameter of a communication record; and
a report record generator that generates a report record that comprises the event data and is linked to the communication record when the key parameter of the event data matches the parameter of the communication record.

22. The system of claim 21, further comprising:
a customer relationship management module that completes the offline conversion; and
an agent console module that receives the information of the offline conversion, and, in response to receiving the information, executes the event data generator, event data transmitter, parameter comparator, and report record generator.

23. The system of claim 22, wherein the customer relationship management module completes a plurality of offline conversions;
wherein the agent console module receives the information of the plurality of offline conversions, and, in response to receiving the information, executes the event data generator, event data transmitter, parameter comparator, and report record generator for each offline conversion of the plurality of offline conversions; and
wherein the event data comprises information of the plurality of offline conversions stored as a plurality of key parameters and one or more additional parameters.

24. The system of claim 21, further comprising
a customer relationship management module that completes the offline conversion and, in response to the completion of the offline conversion, executes the event data generator, event data transmitter, parameter comparator, and report record generator.
